(19) United States
(12) Patent Application Publication
(10) Pub. No.: US 2012/0056881 A1
(43) Pub. Date: Mar. 8, 2012

(54) STEREOSCOPIC IMAGE DISPLAY CONTROL APPARATUS, AND METHOD AND PROGRAM FOR CONTROLLING OPERATION OF SAME

(75) Inventor: Kei YAMAJI, Tokyo (JP)

(73) Assignee: FUJIFILM CORPORATION, Tokyo (JP)

(21) Appl. No.: 13/217,563

(22) Filed: Aug. 25, 2011

(30) Foreign Application Priority Data
Sep. 6, 2010 (JP) 2010-199025

(51) Int. Cl. G06T 15/00

(52) U.S. Cl. 345/419

(57) ABSTRACT

A parallax adjusting command is applied when a stereoscopic image is displayed in an image compositing area defined on a page constituting an electronic album. The amount of parallax is enlarged in response to application of a command for enlarging the amount of parallax. If enlarging the amount of parallax results in margins being produced when the stereoscopic image is displayed in the image compositing area, the enlargement of the amount of parallax is not reflected in the display of the stereoscopic image. Thus, margins are prevented from being produced in the image compositing area.

### BACKGROUND OF THE INVENTION

1. Field of the Invention

This invention relates to a stereoscopic image display control apparatus and to a method and program for controlling the operation of this apparatus.

2. Description of the Related Art

There is a technique for eliminating a gap between an image and a photo frame when an image is pasted in the photo frame of an electronic album (see Japanese Patent Application Laid-Open No. 2006-134230). Further, since the amount of stereoscopic pop-up (depth perception) of a stereoscopic image is not uniquely decided when a stereoscopic image is displayed, there are techniques for adjusting the amount of pop-up (see Japanese Patent Application Laid-Open Nos. 2010-45584 and 8-205203). Since the amount of pop-up varies depending upon enlargement and reduction of image size, there is a technique for determining whether a changed amount of pop-up falls within parallax limits (see Japanese Patent No. 4259913).

In cases where an image compositing area has been defined, however, problems can arise when a stereoscopic image is pasted in such an image compositing area. No consideration whatsoever has been given to such problems.

### SUMMARY OF THE INVENTION

An object of the present invention is to so arrange it that a margins can be eliminated from an image compositing area when a stereoscopic image is displayed in the image compositing area.

A stereoscopic image display control apparatus according to the present invention comprises: a display control device (display control means) for controlling a display unit so as to display a superimposed image portion, which is obtained by superimposing a left-eye image and a right-eye image that constitute a stereoscopic image, in an image compositing area; a parallax-amount enlarging device (parallax-amount enlarging means) for enlarging a parallax amount, which is amount of horizontal offset between the left- and right-eye images, in response to a parallax-amount enlarging command; a margin determination device (margin determination means) for determining whether margins will be produced in the image compositing area in response to enlargement of the parallax amount by the parallax-amount enlarging device; and a parallax-amount enlargement nullifying device (parallax-amount enlargement nullifying means) for nullifying enlargement of the parallax amount by the parallax-amount enlargement device in response to a determination by the margin determination device that margins will be produced.

The present invention also provides an operation control method suited to the above-described stereoscopic image display control apparatus. Specifically, the present invention provides a method of controlling operation of a stereoscopic image display control apparatus, comprising the steps of: controlling a display unit so as to display a superimposed image portion, which is obtained by superimposing a left-eye image and a right-eye image that constitute a stereoscopic image, in an image compositing area; enlarging a parallax amount, which is amount of horizontal offset between the left- and right-eye images, in response to a parallax-amount enlarging command; determining whether margins will be produced in the image compositing area in response to enlargement of the parallax amount; and nullifying enlargement of the parallax amount in response to a determination that margins will be produced.

The present invention further provides a computer-readable program for implementing the above-described method of controlling operation of a stereoscopic image display control apparatus. It may also be arranged to provide a recording medium, on which this program has been stored, removably inserted into a computer.

In accordance with the present invention, a superimposed image portion, which is obtained by superimposing a left-eye image and a right-eye image that constitute a stereoscopic image, is displayed in an image compositing area. When a parallax-amount enlargement command is applied, this enlarges the amount of parallax, which is the amount of horizontal offset between the left- and right-eye images. If the amount of parallax is enlarged, the width of the superimposed image portion in the horizontal direction decreases. Enlarging the amount of parallax, therefore, causes margins to be produced in the image compositing area. In the present invention, whether margins will be produced in the image compositing area by enlargement of the amount of parallax is determined. If it is determined that margins will be produced, then the processing that enlarges the amount of parallax is nullified. This makes it possible to prevent margins from being formed in the image compositing area.

The apparatus further comprises a first image enlarging device (first image enlarging means) for enlarging the left- and right-eye images in response to the parallax amount being enlarged up to a limit parallax amount at which borders will not be produced.

The apparatus further comprises: a nullification halting device (nullification halting means) for halting nullification of enlargement of the parallax amount by the parallax-amount enlargement nullifying device in response to a determination by the margin determination device that margins will be produced; and a second image enlarging device (second image enlarging means) for enlarging the left- and right-eye images in response to halting of nullification by the nullification halting device.

The apparatus further comprises a parallax-amount reducing device (parallax-amount reducing means) for reducing the parallax amount in response to a parallax-amount reducing command; and a third image enlarging device (third image enlarging means) for enlarging the left- and right-eye images in response to reduction of the parallax amount by the parallax-amount reducing device.

By way of example, the third image enlarging device enlarges the left- and right-eye images in such a manner that horizontal length of the superimposed image portion will be the same as transverse length of the image compositing area.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a personal computer;

FIG. 2 is an example of a window for editing an electronic album;

FIG. 3 is an example of an image of a page constituting an electronic album;

FIG. 4 is a flowchart illustrating processing for generating an electronic album;

FIGS. 5A and 5B illustrate a left-eye image and a right-eye image, respectively;

FIG. 6 illustrates an example of a stereoscopic image;

FIG. 7 illustrates the manner in which amount of parallax is enlarged;

FIG. 8 illustrates the manner in which amount of parallax is enlarged further;

FIG. 9 illustrates the manner in which amount of parallax is reduced;

FIG. 10 is a flowchart illustrating a portion of processing for generating an electronic album;

FIG. 11 illustrates the manner in which a stereoscopic image is enlarged in size;

FIGS. 12 and 13 are flowcharts illustrating a portion of processing for generating an electronic album; and

FIG. 14 illustrates the manner in which a stereoscopic image is enlarged in size after the amount of parallax is reduced.

### DESCRIPTION OF THE PREFERRED EMBODIMENTS

Preferred embodiments of the present invention will be described in detail with reference to the drawings.

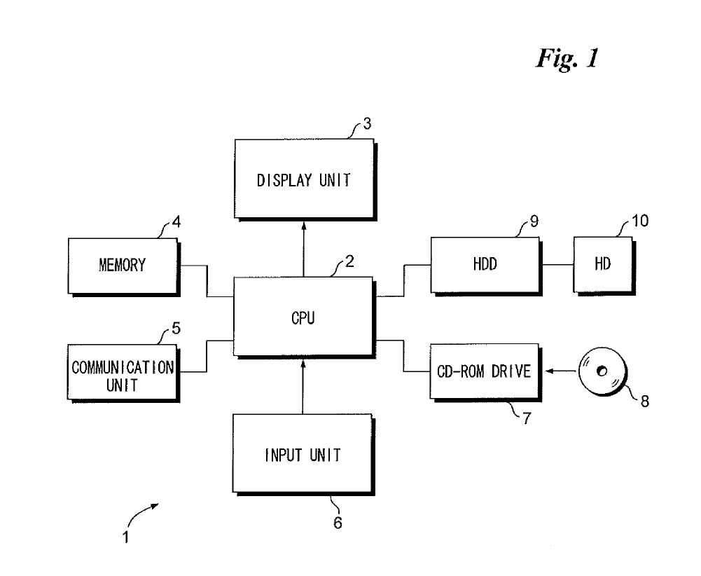

FIG. 1 is a block diagram illustrating the electrical configuration of a personal computer 1 according to an embodiment of the present invention. In this embodiment, the personal computer 1 communicates with a server computer (not shown) via the Internet. While communicating with the server computer, the user creates an electronic album using the personal computer 1. Naturally, the user may generate an electronic album without communicating with the server computer and is also capable of generating an electronic album utilizing a store terminal, which has been installed at a supermarket or convenience store, etc., without using the personal computer 1. In this case, the store terminal would have the electrical configuration shown in FIG. 1.

The overall operation of the personal computer 1 is controlled by a CPU 2.

The personal computer 1 includes a display unit 3, a memory 4, a communication unit 5 for communicating with a server computer, and an input unit 6 such as a keyboard and mouse. The personal computer 1 includes a hard disk 10 on which data such as image data representing a number of images has been recorded, and a hard-disk drive 9 for accessing the hard disk 10. The personal computer 1 further includes a CD-ROM drive 7 that accesses a CD-ROM 8 in which has been stored a program for controlling operation described below. The program that has been stored in the CD-ROM 8 is read by the CD-ROM drive 7 and the read program is installed in the personal computer 1, thereby allowing the personal computer 1 to operate in the manner described below. Naturally, it may be so arranged that even if the operation program is not stored on a recording medium such as the CD-ROM 8 removably inserted into the personal computer 1, the program can still be downloaded to the personal computer 1 via a network and installed in the personal computer 1.

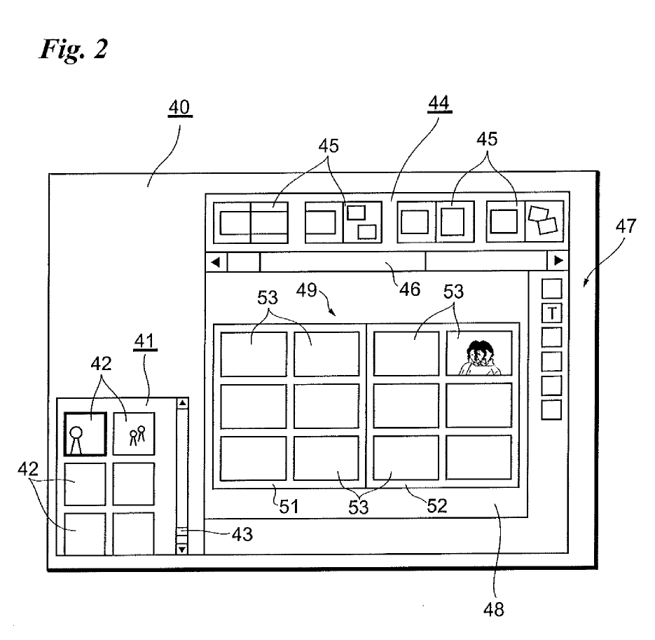

FIG. 2 is an example of a window 40 for editing the electronic album.

Although processing for generating the electronic album will be described below, it will be assumed here that the personal computer 1 has already been connected to a server computer and that the electronic-album editing window 40 shown in FIG. 2 is being displayed on the display screen of the display unit 3 of the personal computer 1.

Formed at the lower-left portion of the editing window 40 is an image display area 41 in which images 42 to be pasted into the electronic album are displayed. The images (user images) 42 being displayed in the image display area 41 are represented by image data that has been stored on the hard disk 10. In a case where the electronic album is created using a store terminal, it goes without saying that the user brings a recording medium such as a memory card on which the image data has been recorded, reads the image data from the recording medium and displays the images, which are represented by the read image data, in the image display area 41. In such case the store terminal is provided with a memory card reader and a scroll button 43 is formed on the right side of the image display area 41. The scroll button 43 is moved freely up and down by a cursor (not shown). By moving the scroll button 43 up or down by the cursor, images that do not appear in the image display area 41 come into view in the image display area 41.

In this embodiment, stereoscopic images can be displayed in the electronic album, as will be described later in detail. The images 42 being displayed in the image display area 41 also are stereoscopic images. With regard to the images 42 being displayed in the image display area 41, amount of parallax (described later) can be enlarged and reduced freely. On the other hand, enlargement of amount of parallax is limited with regard to stereoscopic images displayed in image compositing areas 53 that have been formed in an image 49 of a page displayed in an editing area 48, described next.

Formed at the upper portion of the editing window 40 is a page display area 44 in which images 45 of pages (templates) constituting an electronic album are displayed. A scroll button 46 is formed beneath the page display area 44. The scroll button 46 also is freely movable to the left and right by a cursor (not shown). By moving the scroll button 46 to the left or right using the cursor, the images of pages that do not appear in the page display area 44 come into view in the page display area 44.

The editing area 48, which is for editing the pages that constitute the electronic album, is formed substantially over the entirety of the editing window 40. If the image of a desired page is selected (as by drag and drop) from among the images of the pages being displayed in the page display area 44, the image 49 of the selected page will be displayed in the editing area 48. Multiple (or a single) rectangular image compositing areas 53 (though they need not necessarily be rectangular) are defined in each of a left-side page 51 and right-side page 52 of the image 49 of the selected pages. Images constituting the electronic album are pasted in the image compositing areas 53. For example, pasting of a desired image in a desired image compositing area 53 from among the images 42 being displayed in the image display area 41 is achieved by dragging and dropping the desired image in this image compositing area 53. Formed on the right side of the editing window 40 are editing buttons 47 for synthesizing text, deleting images and subjecting images to a color conversion. As mentioned above, an image that is pasted in the image compositing area 53 is a stereoscopic image. Enlargement of the amount of parallax of this stereoscopic image is limited in such a manner that margins will not be produced in the image compositing area 53.

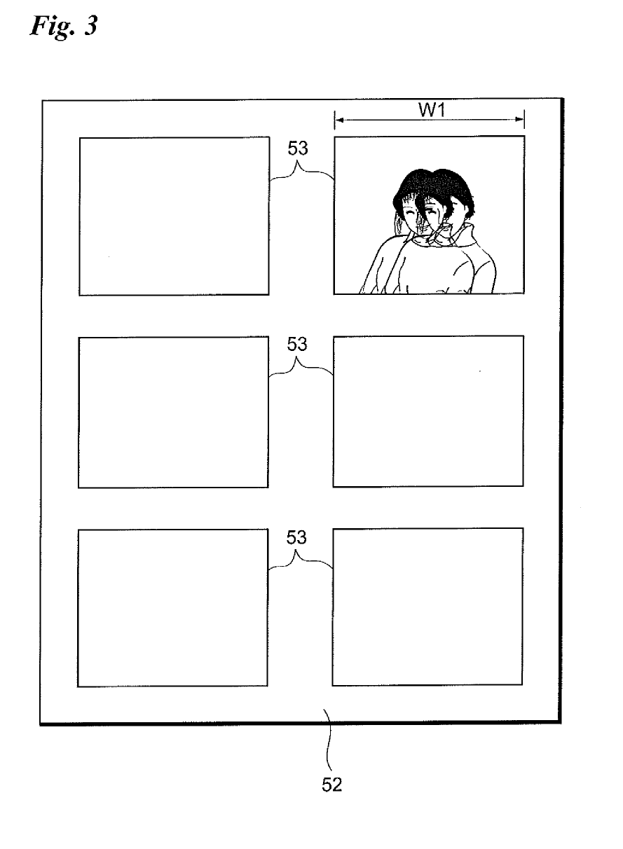

FIG. 3 illustrates the right-side page 52, which is being displayed in the editing area 48 of the editing window 40, in a form enlarged in comparison with FIG. 2.

Thus, a plurality of the image compositing areas 53 are formed on the page 52 constituting the electronic album. Images are pasted in these image compositing areas 53. In particular, in this embodiment, stereoscopic images are pasted in the image compositing areas 53. The user can thus produce an electronic album of stereoscopic images.

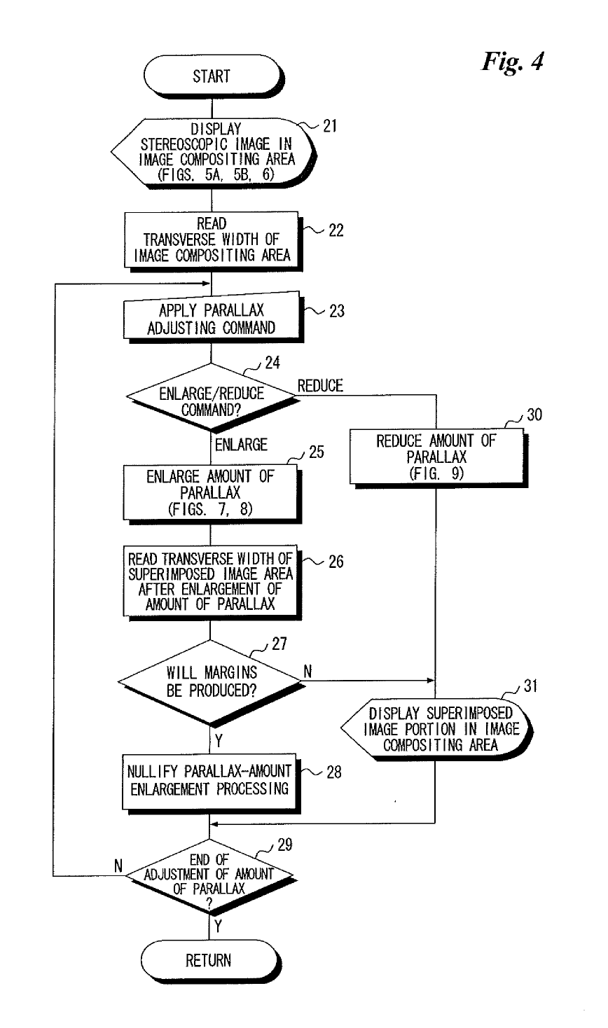

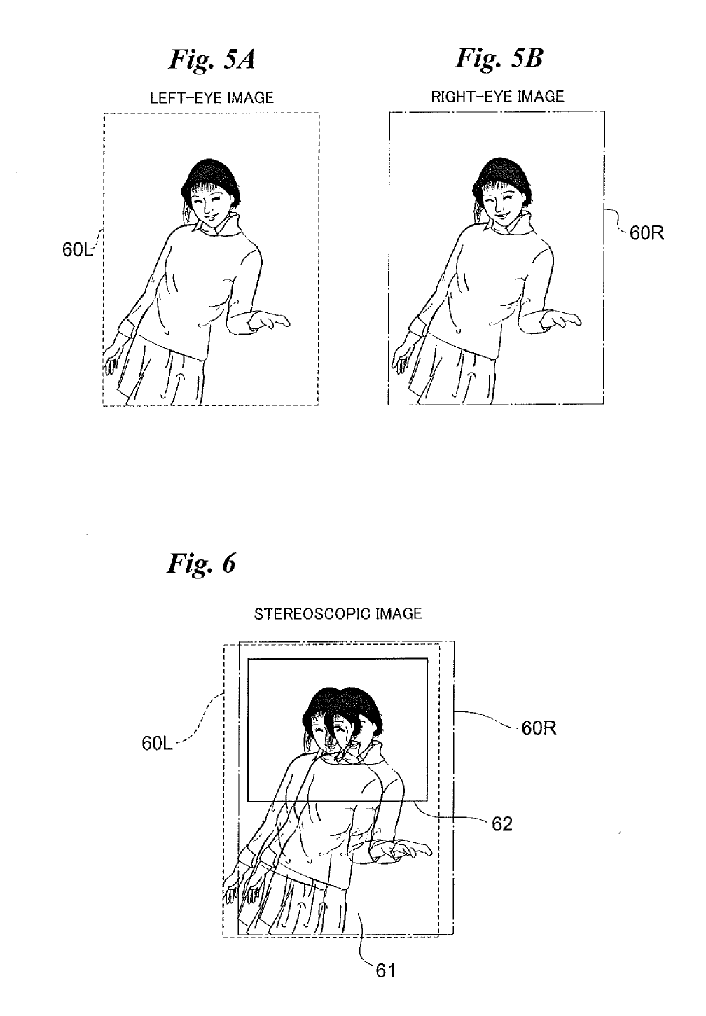

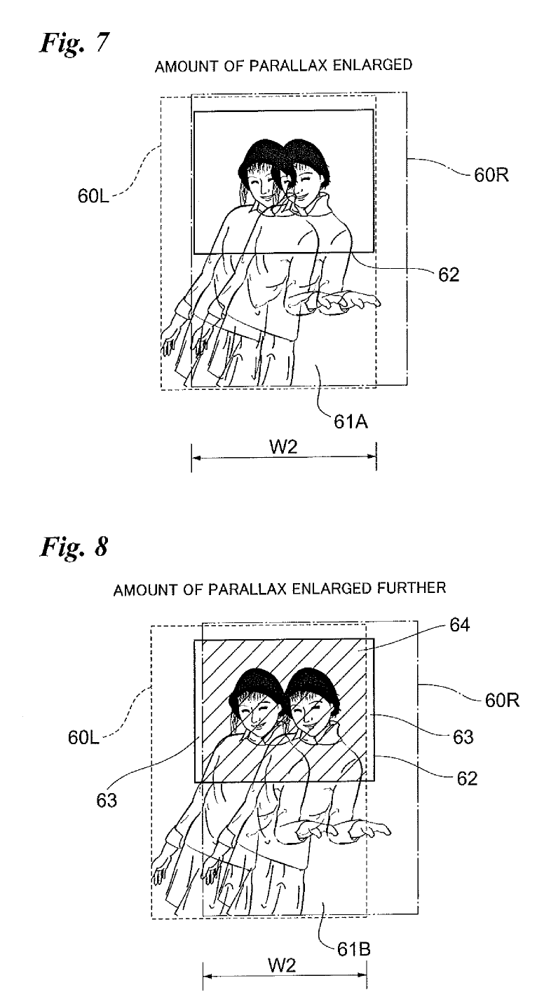

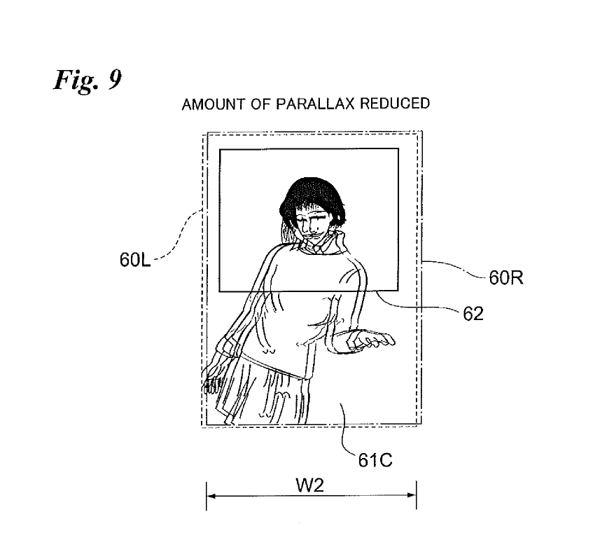

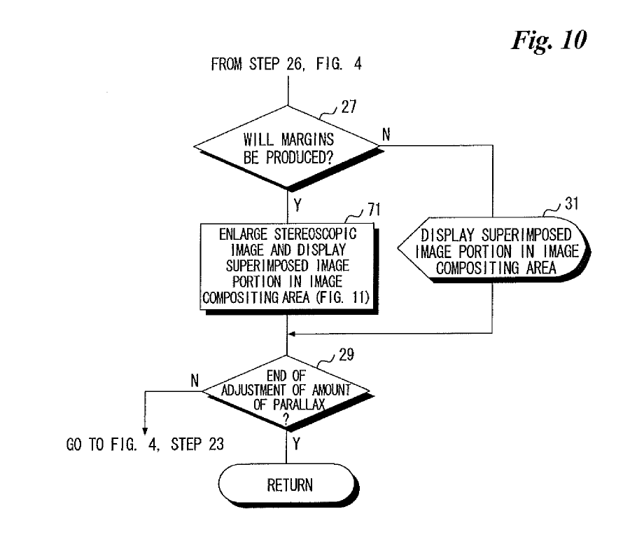

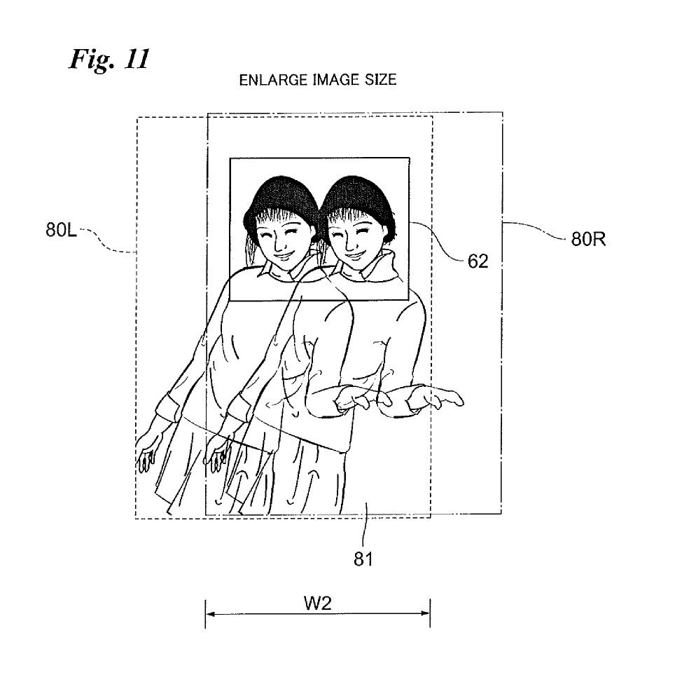

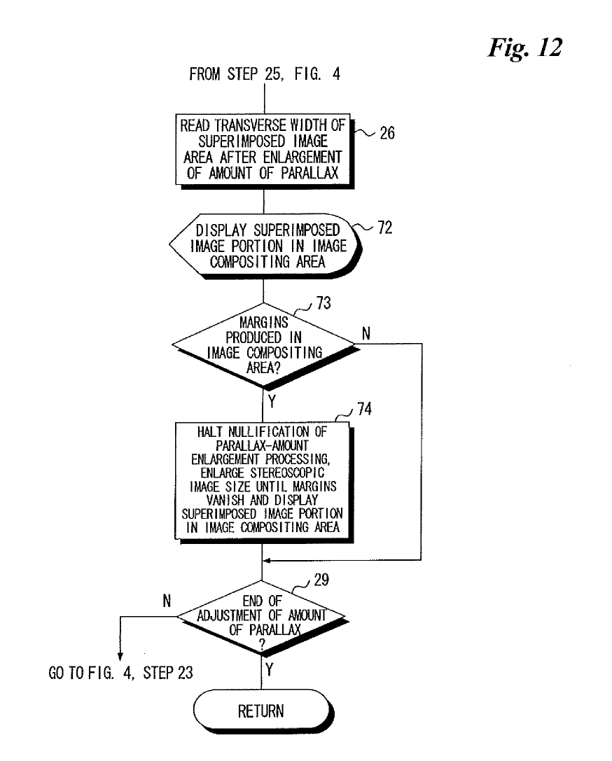

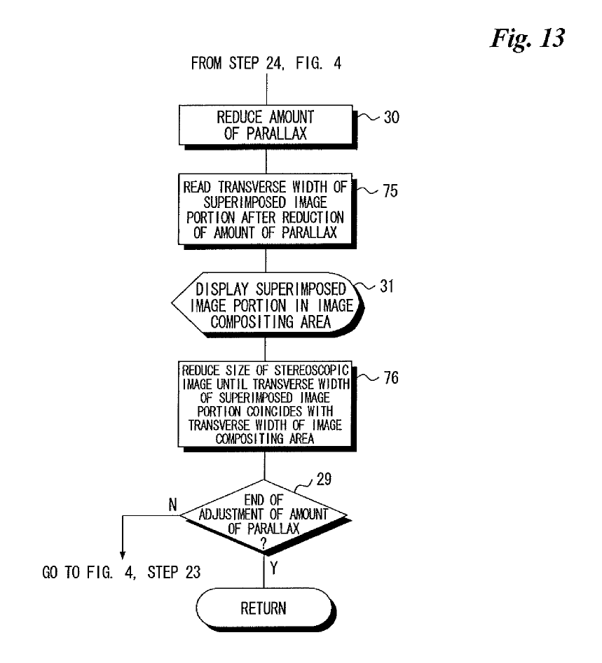

FIG. 4 is a flowchart illustrating processing for generating an electronic album.

A desired image 42 is selected from among the images 42 being displayed in the image display area 41. The image 42 selected is pasted in a desired image compositing area 53. When this is done, the stereoscopic image of the selected image 42 is displayed in the image compositing area 53 (step 21).

FIG. 5A illustrates a rectangular left-eye image 60L and FIG. 5B illustrates a rectangular right-eye image 60R.

In a case where a stereoscopic image is displayed, the left-eye image 60L, which is observed by the left eye of the observer, and the right-eye image 60R, which is observed by the right eye of the observer, are required. In this embodiment, therefore, the left-eye image 60L and right-eye image 60R have been stored beforehand as the images desired to be displayed in the form of a stereoscopic image in the image compositing area 53. The left-eye image 60L and right-eye image 60R need not be rectangular.

FIG. 6 illustrates a stereoscopic image.

If the left-eye image 60L and right-eye image 60R are superimposed upon being offset from each other in the horizontal direction (the amount of horizontal offset is the amount of parallax), then the observer can view a portion 61, where the two images have been superimposed, as a stereoscopic image. In this embodiment, an image portion within a zone 62 contained in the superimposed image portion 61 and having the same size as that of the image compositing area 53 is displayed in the image compositing area 53. The image displayed in the image compositing area 53 appears as a stereoscopic image.

With reference again to FIG. 4, the transverse width w1 of the image compositing area 53 in which the stereoscopic image has been displayed is read (step 22).

Next, a parallax adjustment command is applied by the user (step 23). The editing buttons 47 include a parallax adjustment command button, which is used to apply parallax adjustment commands for enlarging and reducing the amount of parallax.

When a command for enlarging the amount of parallax is applied (step 24), the amount of parallax is enlarged in response to this command (step 25). When the amount of parallax is enlarged, the width w2 of the superimposed image portion prevailing after the enlargement of the amount of parallax is read (step 26).

FIG. 7 illustrates a stereoscopic image the amount of parallax of which has been enlarged in comparison with the stereoscopic image shown in FIG. 6.

When the parallax-amount enlargement command is applied, the left-eye image 60L and right-eye image 60R are positioned so as to separate from each other in accordance with the amount of enlargement of parallax decided by the enlargement command. When the amount of parallax is enlarged, the width w2 of an image portion 61A where the left-eye image 60L and right-eye image 60R are superposed becomes smaller in comparison with that before the amount of parallax was enlarged.

FIG. 8 illustrates a stereoscopic image the amount of parallax of which has been enlarged further in comparison with FIG. 7.

When the amount of parallax is enlarged further, the transverse width w2 of an image portion 61B where the left-eye image 60L and right-eye image 60R are superposed becomes even smaller. As a result, from within the zone 62 corresponding to the image compositing area 53, an image portion (indicated by hatching) 64 contained in the superimposed image portion 61B is displayed in the image compositing area 53. Image portions 63 on both sides of the image portion 64 indicated by the hatching are not displayed in the image compositing area 53. Borders are formed on both sides of the image compositing area 53.

With reference again to FIG. 4, whether margins will be produced in the image compositing area 53 in a case where the stereoscopic image after enlargement of the amount of parallax thereof is displayed in the image compositing area 53 is determined from the transverse width w1 of the image compositing area 53 and the transverse width w2 of the superimposed image portion prevailing after enlargement of the amount of parallax (step 27). If the transverse width w2 of the superimposed image portion 61A prevailing after enlargement of the amount of parallax is less than the transverse width w1 of the image compositing area 53, it is determined that borders will be produced in the image compositing area 53. If the transverse width w2 of the superimposed image portions 61A, 61B, etc. prevailing after enlargement of the amount of parallax is equal to or greater than the transverse width of the image compositing area 53, then it is determined that margins will not be produced in the image compositing area 53.

If the amount of enlargement of parallax is small and margins will not be produced in the image compositing area 53 (“NO” at step 27), as illustrated in FIG. 7, then the enlargement command is reflected in the display of the stereoscopic image. The image portion of the zone 62 contained in the superimposed image portion 61A prevailing after enlargement of the amount of parallax is displayed in the image compositing area 53 (step 31). If the adjustment of the amount of parallax is not finished (“NO” at step 29), processing from step 23 onward is repeated.

If the amount of enlargement of parallax is large and margins will be produced in the image compositing area 53 (“YES” at step 27), as illustrated in FIG. 7, then the enlargement command is not reflected in the display of the stereoscopic image and the processing for enlarging the amount of parallax is nullified (step 28). The processing for enlarging the amount of parallax is ignored. Preferably, a message is displayed to the effect that enlargement of the amount of parallax will not be carried out because such processing would produce margins. If the adjustment of the amount of parallax is not finished (“NO” at step 29), processing from step 23 onward is repeated.

If a command for reducing the amount of parallax is applied (step 24), then processing for reducing the amount of parallax is executed (step 30).

FIG. 9 is an example of a stereoscopic image that has undergone processing for reducing amount of parallax.

When processing for reducing amount of parallax is executed, the left-eye image 60L and right-eye image 60R approach each other in the horizontal direction. Since the transverse width w2 of an image portion 61C where the left-eye image 60L and right-eye image 60R are superposed is greater than the transverse width w1 of the image compositing area 53, a margin will not be produced in the image compositing area 53. Consequently, the image within the zone 62 contained in the superimposed image portion 61C is displayed in the image compositing area 53.

In the embodiment described above, margins can be prevented from being produced in the image compositing area 53 because the enlargement of the amount of parallax is limited.

In the foregoing embodiment, it is assumed that margins will not be produced in the state shown in FIG. 6 (an initial state before a command for enlarging or reducing amount of parallax is applied, e.g., a state defined by an initial amount of parallax that has been applied to the left-eye image 60L and right-eye image 60R). However, in a case where margins will be produced in the state shown in FIG. 6, the above-described processing would be executed after the amount of parallax has been reduced in such a manner that margins will not be produced.

FIGS. 10 and 11 illustrate another embodiment.

FIG. 10 is a flowchart illustrating a portion of processing for generating an electronic album. Processing steps in FIG. 10 identical with those shown in FIG. 4 are designated by like step numbers and need not be described again.

In the foregoing embodiment, enlargement of the amount of parallax that would result in margins is nullified. In this embodiment, on the other hand, if the amount of parallax is enlarged up to a limit amount of parallax that will not result in margins being produced in the image compositing area 53, then the stereoscopic image is enlarged in size (step 71).

FIG. 11 illustrates the manner in which a stereoscopic image is enlarged in size.

The left-eye image 60L is enlarged in size and becomes an enlarged left-eye image 80L. The right-eye image 60R also is enlarged in size and becomes an enlarged right-eye image 80R. The transverse width w2 of an image portion 81 where the enlarged left-eye image 80L and enlarged right-eye image 80R are superimposed is greater than the transverse width w1 of the image compositing area 53 (enlargement is performed in such a manner that the transverse width w2 of the superimposed image portion 81 after enlargement will be greater than the transverse width w1 of the image compositing area 53). The image portion within the zone 62 contained in the superimposed image portion 81 is displayed in the image compositing area 53 (step 71). Thus the amount of parallax is enlarged without margins being produced in the image compositing area 53.

The amount of parallax can be enlarged further within limits that will not cause margins to be produced in the image compositing area 53.

In a case where the amount of parallax is enlarged so much that margins are produced in the image compositing area 53, enlargement processing is nullified according to the processing shown in FIG. 4.

By contrast, with the processing shown in FIG. 10, the stereoscopic image is enlarged in size. However, the processing shown in FIG. 4 and the processing shown in FIG. 10 may be set for each electronic-album generation processing program and the user can select which type of processing to use.

FIG. 12 is a flowchart illustrating a portion of processing for generating an electronic album according to a further embodiment. Processing steps in FIG. 12 identical with those shown in FIG. 4 are designated by like step numbers and need not be described again.

The processing shown in FIGS. 10 and 11 is such that if margins will be produced in the image compositing area 53 by enlarging the amount of parallax, the stereoscopic image will be enlarged in size without displaying the margins. In this embodiment, on the other hand, if margins will be produced in the image compositing area 53 by enlarging the amount of parallax, then the borders are eliminated by enlarging the size of the stereoscopic image after the borders are displayed.

When the amount of parallax is enlarged and the transverse width of the superimposed image portion prevailing after the enlargement of the amount of parallax is read (step 26), as illustrated in FIG. 8, the image portion (indicated by hatching) 64 contained in the zone 62 from within the superimposed image portion 61B is displayed in the image compositing area 53 (step 72). If margins are produced in the image compositing area 53 (“YES” at step 73), nullification of the parallax-amount enlargement processing is halted, whereupon the left-eye image 60L and right-eye image 60R are enlarged in size, as shown in FIG. 11, until margins are no longer produced. The image inside the zone 62 from within the portion where the left-eye image 60L and right-eye image 60R are superimposed is displayed in the image compositing area 53 (step 74). If margins are not produced in the image compositing area 53 (“NO” at step 73), then the processing of step 74 is skipped.

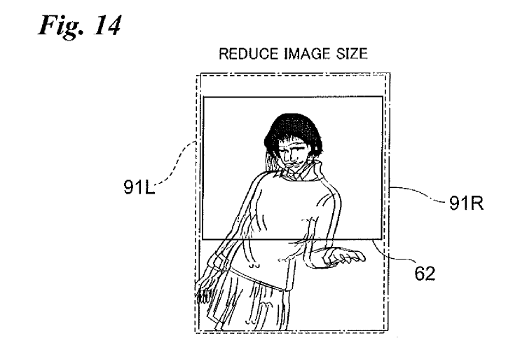

FIGS. 13 and 14 illustrate yet another embodiment of the present invention.

FIG. 13 is a flowchart illustrating a portion of processing for generating an electronic album. Processing steps in FIG. 13 identical with those shown in FIG. 4 are designated by like step numbers and need not be described again.

This embodiment is such that when the command for reducing the amount of parallax is applied and the amount of parallax is reduced in the manner shown in FIG. 9 (step 30), the transverse width w2 of the superimposed image portion 61C prevailing after the reduction in amount of parallax is read (step 75). The image in zone 62 from within the superimposed image portion 61C is displayed in the image compositing area 53 (step 31). By reducing the amount of parallax, the transverse width w2 of the superimposed image portion becomes smaller than the transverse width w1 of the image compositing area 53 (zone 62). The stereoscopic image (left-eye image 60L and right-eye image 60R) is therefore reduced in size in such a manner that the transverse width w2 of the superimposed image portion will become identical with the transverse width w1 of the image compositing area 53 (zone 62) (step 76).

FIG. 14 illustrates the manner in which the stereoscopic image is reduced in size. The left-eye image 60L shown in FIG. 9 is reduced in size and becomes a left-eye image 91L. Similarly, the right-eye image 60R shown in FIG. 9 is reduced in size and becomes a right-eye image 91R. By executing such size reduction processing, the proportion of the image contained in the zone 62 increases. Since the image inside the zone 62 is displayed in the image compositing area 53, the result is that an enlarged stereoscopic image is displayed in the image compositing area 53.

In the embodiment described above, processing that will not result in margins being produced in the image compositing area 53 is executed. Whether or not this processing is applied may be decided in accordance with the layout of the image compositing areas 53 in the image of the page constituting the electronic album (the image compositing areas 53 may be formed on a single mounting sheet without necessarily constructing an electronic album). For example, it may be so arranged that if there are a plurality of identically shaped rectangular image compositing areas on a page constituting an electronic album and the left and right side edges of the image compositing areas in the same column are aligned as well as the upper and lower edges of the image compositing areas in the same row, then processing that will not result in margins being produced in the image compositing areas is executed in the manner set forth above.

As many apparently widely different embodiments of the present invention can be made without departing from the spirit and scope thereof, it is to be understood that the invention is not limited to the specific embodiments thereof except as defined in the appended claims.

What is claimed is:

1. A stereoscopic image display control apparatus comprising:
a display control device for controlling a display unit so as to display a superimposed image portion, which is obtained by superimposing a left-eye image and a right-eye image that constitute a stereoscopic image, in an image compositing area;
a parallax-amount enlarging device for enlarging a parallax amount, which is amount of horizontal offset between the left- and right-eye images, in response to a parallax-amount enlarging command;
a margin determination device for determining whether margins will be produced in the image compositing area in response to enlargement of the parallax amount by said parallax-amount enlarging device; and
a parallax-amount enlargement nullifying device for nullifying enlargement of the parallax amount by said parallax-amount enlargement device in response to a determination by said margin determination device that margins will be produced.

2. The apparatus according to claim 1, further comprising a first image enlarging device for enlarging the left- and right-eye images in response to the parallax amount being enlarged by said parallax-amount enlarging device up to a limit parallax amount at which borders will not be produced.

3. The apparatus according to claim 1, further comprising:
a nullification halting device for halting nullification of enlargement of the parallax amount by said parallax-amount enlargement nullifying device in response to a determination by said margin determination device that margins will be produced; and
a second image enlarging device for enlarging the left- and right-eye images in response to halting of nullification by said nullification halting device.

4. The apparatus according to claim 1, further comprising:
a parallax-amount reducing device for reducing the parallax amount in response to a parallax-amount reducing command; and
a third image enlarging device for enlarging the left- and right-eye images in response to reduction of the parallax amount by said parallax-amount reducing device.

5. The apparatus according to claim 4, wherein said third image enlarging device enlarges the left- and right-eye images in such a manner that horizontal length of the superimposed image portion will be the same as transverse length of the image compositing area.

6. A method of controlling operation of a stereoscopic image display control apparatus, comprising the steps of:
controlling a display unit so as to display a superimposed image portion, which is obtained by superimposing a left-eye image and a right-eye image that constitute a stereoscopic image, in an image compositing area;
enlarging a parallax amount, which is amount of horizontal offset between the left- and right-eye images, in response to a parallax-amount enlarging command;
determining whether margins will be produced in the image compositing area in response to enlargement of the parallax amount; and
nullifying enlargement of the parallax amount in response to a determination that margins will be produced.

7. A computer-readable program for controlling a computer of a stereoscopic image display control apparatus so as to:
control a display unit so as to display a superimposed image portion, which is obtained by superimposing a left-eye image and a right-eye image that constitute a stereoscopic image, in an image compositing area;
enlarge a parallax amount, which is amount of horizontal offset between the left- and right-eye images, in response to a parallax-amount enlarging command;
determine whether margins will be produced in the image compositing area in response to enlargement of the parallax amount; and
nullify enlargement of the parallax amount in response to a determination that margins will be produced.
